(19) United States
(12) Patent Application Publication
(10) Pub. No.: US 2006/0273524 A1
(43) Pub. Date: Dec. 7, 2006

(54) Ring seal with an anti-rotation tab

(76) Inventors: Leo S. Weber, Commerce Township, MI (US); James A. Springer, Ann Arbor, MI (US); William J. Goodrich, Livonia, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/144,250

(22) Filed: Jun. 3, 2005

(51) Int. Cl. F16J 15/34

(52) U.S. Cl. 277/372

(57) ABSTRACT

A ring seal has an annular body and a radially inwardly extending tab member. The tab member is effectively associated or combined with a slot formed in a shaft or other rotating object to prevent rotation of the seal relative to the rotating member. The ring seal has two sides of sealing surfaces, which are annular, and one radially outer circumferential sealing surface.

### TECHNICAL FIELD

This invention relates to sealing mechanisms and, more particularly, to a ring seal wherein an anti-rotation mechanism is employed.

### BACKGROUND OF THE INVENTION

Many of the current automatic shifting transmissions employ ring seals between rotating parts. These parts generally rotate at different speeds and therefore have hydraulic pressures flowing between the rotating parts. The seal is designed to prevent the leakage of fluid from one side of the seal to the other. In many applications, it is desirable to prevent rotation of the ring seal relative to one of the moving parts.

The prior art has chosen to provide an axially extending tab, which is inserted in an axial slot formed in a shaft to retain the seal from rotating relative to the shaft on which it is mounted. While these seals are effective in preventing axial leakage past the outside diameter of the seal, they are operable in only one direction. The axially extending tab thereof is fitted into an axial slot and therefore does not prevent leakage in a direction toward the slot and tab. Also, the axial slot required for the tab takes up valuable axial space within the assembly in many instances.

### SUMMARY OF THE INVENTION

It is an object of the present invention to provide an improved ring seal having an anti-rotation structure formed thereon.

In one aspect of the present invention, the ring seal has a radially extending tab.

In another aspect of the present invention, the radially extending tab is formed inwardly of the ring seal and is engageable within a slot formed on the part to which it is assembled.

In yet another aspect of the present invention, the ring seal with a radial tab will seal both the outer diameter and both sides of the ring thereby preventing fluid from passing in either axial direction when a third pressure is present.

### DESCRIPTION OF THE DRAWINGS

FIG. 1 is an elevational view of one embodiment of the present invention.

FIG. 2 is a view taken along line 2-2 of FIG. 1.

FIG. 3 is an elevational view partly in section of a ring seal incorporating the present invention in place in an assembly.

FIG. 4 is a plan view of a portion of the assembly of FIG. 3 depicting the retaining mechanism on a shaft.

### DESCRIPTION OF THE EXEMPLARY EMBODIMENTS

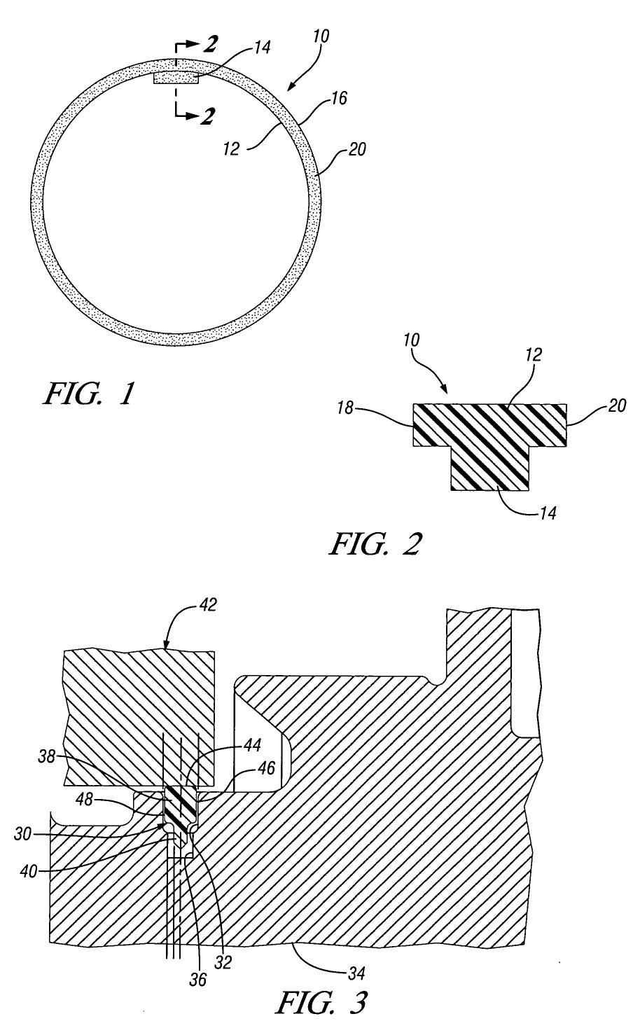

Referring to FIGS. 1 and 2, there is seen a ring seal 10 having an annular portion 12 and a tab portion 14. The tab portion 14 extends radially inward and axially from the annular portion 12. The annular portion 12 has an outer rim 16 and side surfaces 18 and 20. When assembled with a rotating component, the tab 14 is placed in a slot formed in the rotating component. Since the tab 14 is radially inward of the sealing side surfaces 18 and 20, this seal ring 10 does not have the disadvantage of the prior art, since the slot for the tab 14 is not axially aligned with either of the of the sealing side surfaces 18 and 20.

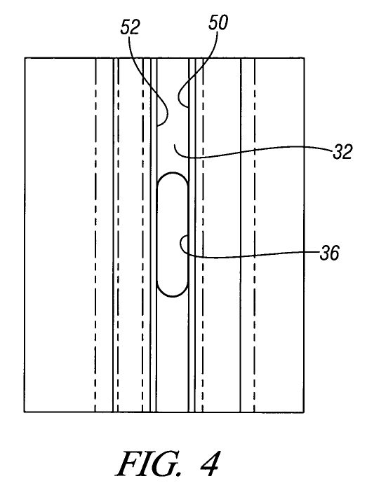

Referring to FIG. 3, there is seen a ring seal 30 disposed in a groove 32 formed in a rotatable shaft 34. The groove 32 has formed therein a radial recess 36, as best seen in FIG. 4. The ring seal 30 has an annular body 38 and a radially inwardly extending tab portion 40. The tab portion 40 is fitted into the slot 36 to prevent rotation of the ring seal 30 relative to the shaft 34. Radially outward of the seal 30 is a transmission component, generally designated 42. The component 42 may be any of a number of rotating parts within a power transmission, such as clutch hub or a drum.

The ring seal 30 has an outer peripheral surface 44 similar to the surface 16 of the ring seal shown in FIG. 1. The ring seal 30 also has side sealing surfaces 46 and 48. The outer surface 44 seals on the component 42, the side surface 46 seals on a side surface 50 of the groove 38 and the side surface 48 seals on a side surface 52 of the groove 32. The tab 40 prevents rotation of the ring seal 30 relative to the shaft 34 when there is a relative speed difference between the shaft 34 and the component 42.

When fluid pressure is admitted to the space between the shaft 34 and the component 42 from the left side of the seal 30, the fluid will flow under the seal to the inner surface thereof forcing the surface 44 to seal against the component 42 and also forcing the surface 46 to seal against the surface 50. Thus, the pressure within the space between the shaft 34 and component 42 will be maintained free of leakage.

In the event that pressure reversal is necessary, such that fluid pressure is admitted from the right side of the seal 30 while the left side is connected to an exhaust, the outer surface 44 will again seal against the component 42 and the side surface 48 will seal against the side 52 of the groove 32. Thus, the seal will have integrity in both directions and will not consume any excess axial space for assembly requirements.

1. A ring seal for use with a shaft comprising:
an annular body portion having a radially outer sealing rim;
a first side sealing surface and a second side sealing surface; and
a radially inwardly extending tab member adapted to be positioned within a groove on said member.

2. The ring seal for use with a shaft defined in claim 1 further comprising:
said tab extending both radially inward and axially form a position inward of at least one of said side sealing surfaces.

3. The ring seal for use with a shaft defined in claim 1 further comprising:
said tab extending both radially inward and axially form a position inward of at least one of said side sealing surfaces; and
said shaft being a rotatable member.
